(19) United States
(12) Patent Application Publication
(10) Pub. No.: US 2013/0204656 A1
(43) Pub. Date: Aug. 8, 2013

(54) Method and Application for Batch-Based Queue Management System

(71) Applicant: WEEELS, INC., New York, NY (US)

(72) Inventors: David Drew MAHFOUDA, Brooklyn, NY (US); Benjamin BLUM, Brooklyn, NY (US)

(73) Assignee: WEEELS, INC., New York, NY (US)

(21) Appl. No.: 13/750,671

(22) Filed: Jan. 25, 2013

Related U.S. Application Data
(60) Provisional application No. 61/594,828, filed on Feb. 3, 2012.

(51) Int. Cl. G06Q 10/06

(52) U.S. Cl. CPC G06Q 10/06316
USPC 705/7.26

(57) ABSTRACT

A queue management method and system that is designed to decrease queue times and to more efficiently allocate the queue-resource among queue-members, particularly in cases where multiple independent queue-members can effectively share resources that each member would otherwise consume independently. Users may be batched according to some complementary consumption-characteristic and a segmented queue may be utilized that contains a batched-queue that includes the batches of users and users that have not been assigned to a batch. Priority may be awarded to those in the batched-queues, which may decrease queue times and more efficiently allocate the queue-resource. The system for facilitating batched queue management may contain a series of terminals that acquire user characteristics, a server that batches users according to their characteristics and maintains a queue consisting of batched and non-batched queue-members, and terminals for broadcasting queue information to the users.

### CROSS REFERENCE TO RELATED APPLICATIONS

This application claims priority to U.S. provisional patent application No. 61/594,828, filed on Feb. 3, 2012, the entire disclosure of which is incorporated herein by reference.

### FIELD OF INVENTION

The present invention relates generally to queue management, and more particularly, to the system and method for managing a queue by batching queue-members according to some queue-member characteristic with the resultant effect of decreasing queue times and efficiently allocating the queue-resource among queue-members. Efficiency may be gained by prioritizing the allocation of queue-resources to batches of queue-members instead of individual queue members.

### BACKGROUND

In public spaces, a large amount of time can be spent waiting in queues for goods or services. This is an unproductive use of the queue-member's time and economically inefficient for the enterprise concerned.

Certain types of queue systems for managing customer queues at a plurality of service positions in establishments have been developed for addressing this problem and are previously known. Prior art queue management systems often operate according to the underlying principle of a single, “first-come, first-served” basis, rather than a “maximized users served” model.

Exemplary prior art systems include those discussed in the following patents.

U.S. Pat. No. 3,641,553 discloses a registering and calling system for waiting numbers wherein each customer takes a turn number upon arrival at the establishment. Customers are called to a free service position to be served when their turn comes up.

U.S. Pat. No. 4,675,647 discloses a system for determining a queue sequence for serving customers at a plurality of service positions. This system is similar to U.S. Pat. No. 3,641,553 with the apparent added novelty that it allows customers to select a particular service position at which they desire to be served. Customers are called to a free service position to be served when their turn comes up, taking into consideration their selected service position, if any.

U.S. Pat. No. 6,059,184 discloses a turn number system and method capable of giving priority to specific customers. A customer selects a service type and obtains a turn number for the selected service type. The apparent novelty of this system is that customers whom the establishment wishes to identify and give priority to are provided with individual codes stored on magnetic cards or the like. When a customer with an identity code is called to a service position, information pertaining to the customer is retrieved from a database and presented to the teller at that service position.

None of the known prior art queue systems is capable of efficiently allocating resources among queue-members who share complementary consumption-characteristics.

### SUMMARY OF THE INVENTION

Disclosed and claimed herein are systems and methods for batch-based queue management. In one embodiment, a queue management system includes at least one input terminal that is configured to receive a characteristic from a user. The system may also include a server configured to receive the characteristic from the input terminal, and may be further configured to allocate users into a segmented queue. That segmented queue may include at least one batched queue containing batches of users assigned to a batch at least in part based on a complementary user characteristic and a non-batched queue containing users that have not been assigned to a batch. The system may also contain a broadcast terminal configured to broadcast the assignment of batches to the user. Other aspects, features, and techniques of the invention will be apparent to one skilled in the relevant art in view of the following detailed description of the invention.

### BRIEF DESCRIPTION OF THE DRAWINGS

FIG. 1 depicts a systems diagram showing a batched queuing system in accordance with an embodiment of the present invention that utilizes stationary input terminals.

FIG. 2 depicts an interaction diagram, illustrating exemplary sequential user interfaces of an embodiment of the invention.

FIG. 3 depicts a systems diagram showing a batched queuing system in accordance with an alternative embodiment of the present invention that utilizes mobile input terminals.

FIG. 4 depicts an interaction diagram, illustrating exemplary sequential user interfaces of the alternative embodiment of the invention discussed in FIG. 3.

FIG. 5 depicts a flowchart illustrating a process through which queue-members may participate in a batched-queue system in accordance with an embodiment of the present invention.

FIG. 6 depicts a plan view, illustrating an exemplary spatial configuration of a batched-queue system utilized in an implementation involving allocation of for-hire vehicles.

FIG. 7 depicts a flowchart illustrating an embodiment of the present invention through which queue-members may participate in a batched-queue system.

### DETAILED DESCRIPTION

The present invention provides a batch-based queue management system that may include terminals capable of acquiring, transmitting, and displaying queue-member information and a server that receives, correlates, and transmits queue-member information.

In one embodiment, the system may utilize stationary input terminals, such as entry-terminals or kiosks. In another embodiment, the system may use mobile input terminals. Into those input terminals, a user may enter a characteristic (e.g., a final destination in a vehicle ride sharing implementation). All users that input information will then enter the segmented queue and become queue members. For clarity, references contained herein to a “user” or “queue-member” may also refer to one or more database entries and/or records created by, corresponding to, or otherwise associated with, a particular user.

The server may then allocate queue-members into batched-queues according to complementary characteristics. Non-batched queue-members may remain in the segmented queue as non-batched until the server is able to allocate such queue-member into an appropriate batch. If the user desires to not become batched, or if an appropriate batch does not become available, the user can remain in the segmented queue in the non-batched state. Alternatively, the server may place non-batched queue-members into a secondary queue containing non-batched members.

The server may also determine overall-queue order, as a function of entry order and of the relationship between queue-member characteristics. In one embodiment of the invention, priority in the overall-queue order may be granted to batched queue-members. Granting priority to batched queue-members may decrease the average total queue-time for all queue-members.

Subsequently, broadcast terminals may notify users (e.g., passengers in a vehicle ride sharing implementation) as to the queue order, and may direct the queue-members to an appropriate location to be given access to the queue-resource (e.g., shared vehicle). Alternatively, the mobile input terminal may serve as the broadcast terminal.

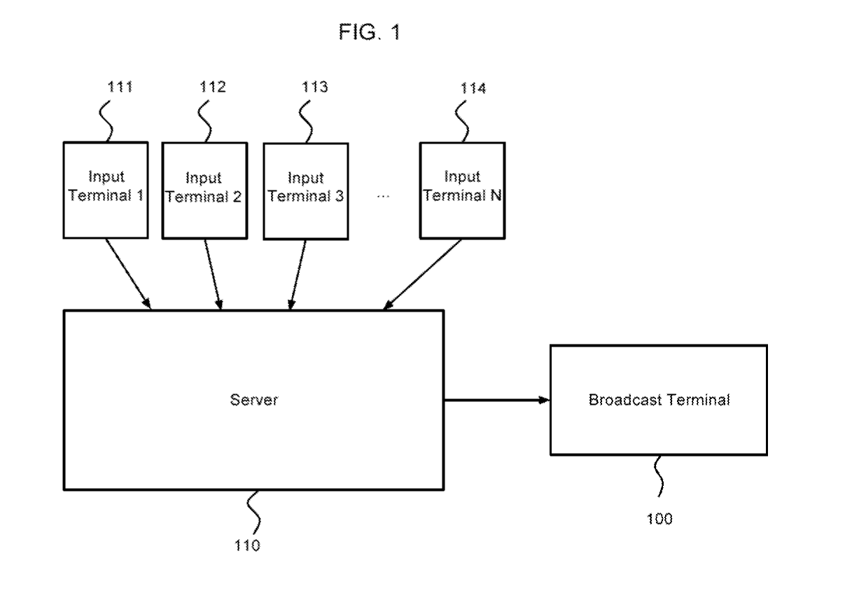

FIG. 1 is a systems diagram illustrating the relationship between input terminals 111, 112, 113 and 114, a server 110 for managing a queue order, and a broadcast terminal 100.

Input terminals 111, 112, 113 and 114 collect queue-member characteristics and communicate them to the server 110.

Input terminals 111, 112, 113 and 114 may include any kind of device that can collect queue-member characteristics and broadcast them via wifi network to a server. Examples of input terminals include stationary kiosks, touch tablets, digital cameras, bar-code scanners, voice recognition devices, and magnetic card readers. In embodiments of the present invention, the input terminals 111, 112, 113 and 114 may employ paneled touch screens, through which the queue-members can indicate their member-characteristics. Similarly, in embodiments of the present invention, the input terminals 111, 112, 113 and 114 terminals may rely solely on audio input, in which case, for example, voice-recognition software may be used to interpret queue-member input. In an alternative embodiment, the input terminals may involve the use of human tellers, who may enter queue-member characteristics into the server manually.

The broadcast terminal 100 may employ both visual and audio output, or solely audio output or solely visual output. In certain implementations, the broadcast terminal may also utilize physical delineations of batched-queues including by using directional markings in a queue area to direct users to a proper location.

The server 110 may allocate users into at least one batched-queue, based on the queue-member characteristics information obtained from the user terminals 111, 112, 113, and 114.

After queue-members are successfully “batched”, the server 110 may communicate resultant batches and relative ordering with queue-members via broadcast terminal 100.

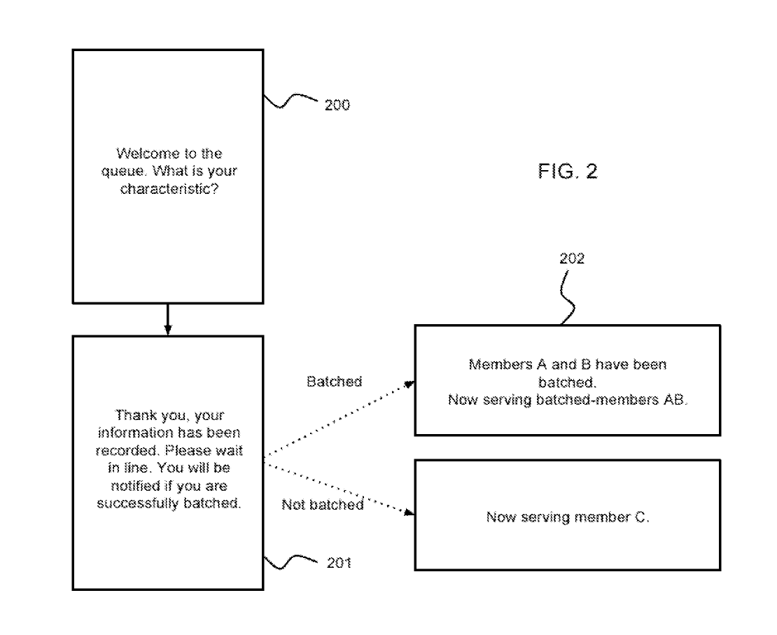

FIG. 2 illustrates exemplary user interfaces of the input terminals 111, 112, 113 and 114 and broadcast terminal 100.

In this exemplary embodiment, a first display depiction 200 of input terminals 111, 112, 113 and 114 is shown where a user may be asked to enter one or more characteristics in the stationary terminal. Subsequently, after a user enters such characteristic(s), a second display depiction 201 on input terminals 111, 112, 113 and 114 may be shown that acknowledges completion of user-input. Subsequently, a display depiction 202 on broadcast terminal 100 may convey batched and non-batched queue-member order, including which users are to be currently served. As noted above, such display depictions may take alternative forms and may implement audio input/output in addition to, or in lieu of, the visual display depictions 200, 201, 202.

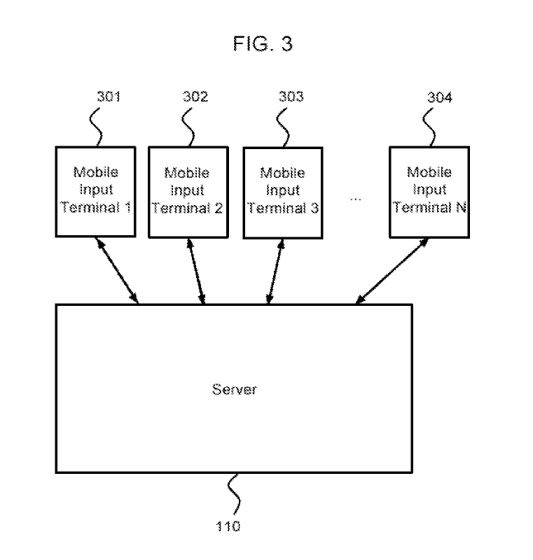

FIG. 3 depicts a systems diagram of an alternative embodiment of the present invention that utilizes mobile input terminals 301, 302, 303 and 304 and a server 110 for managing a queue order. In this embodiment, the mobile input terminals may be employed as personal broadcast terminals (similar to broadcast terminal 100 in the embodiment discussed in FIG. 1).

Mobile input terminals 301, 302, 303 and 304 collect queue-member characteristics and communicate them to the server 110. A mobile input terminal 301, 302, 303 and 304 may include any kind of device which can collect queue-member characteristics, broadcast them via a wifi network to a server, as well as receive and display queue-order information from a server. Examples of mobile input terminals include cellular phones, smart phones, e-readers, and touch tablets.

The server 110 may allocate users into at least one batched-queue, based on the queue-member characteristics information obtained from the mobile input terminals 301, 302, 303, and 304.

After queue-members are successfully “batched”, the server 110 communicates resultant batches and relative ordering with queue-members back to mobile input terminals 301, 302, 303, and 304.

Notably, while this embodiment is being discussed separately, the embodiment discussed with reference to FIG. 3 may be combined with the embodiment discussed with reference to FIG. 1, such that certain users may utilize stationary input terminals 111, 112, 113 and 114, and other users may use mobile input terminals 301, 302, 303, and 304. Similarly, if the embodiments are combined, then certain users may rely on broadcast terminal 100, whereas other users may rely on their mobile input terminals.

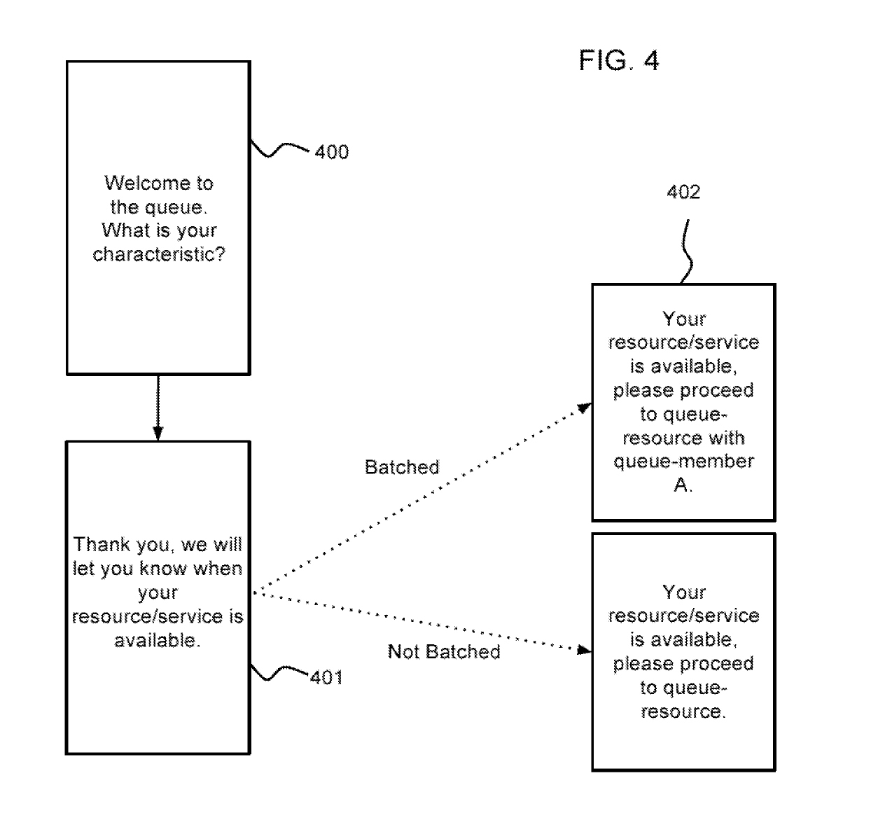

FIG. 4 illustrates exemplary user interfaces of mobile input terminals 301, 302, 303, and 304.

In this exemplary embodiment, a first display depiction 400 on mobile input terminals 301, 302, 303, and 304 is shown where a user may be asked to enter a characteristic in the mobile input terminal. Subsequently, after a user enters such characteristic(s), a second display depiction 401 on mobile input terminals 301, 302, 303, and 304 may be shown that acknowledges completion of user-input. Subsequently, a display depiction 402 on mobile input terminals 301, 302, 303, and 304 may notify the user of the availability of the queue-resource, and their batched/non-batched status, via the mobile input terminal.

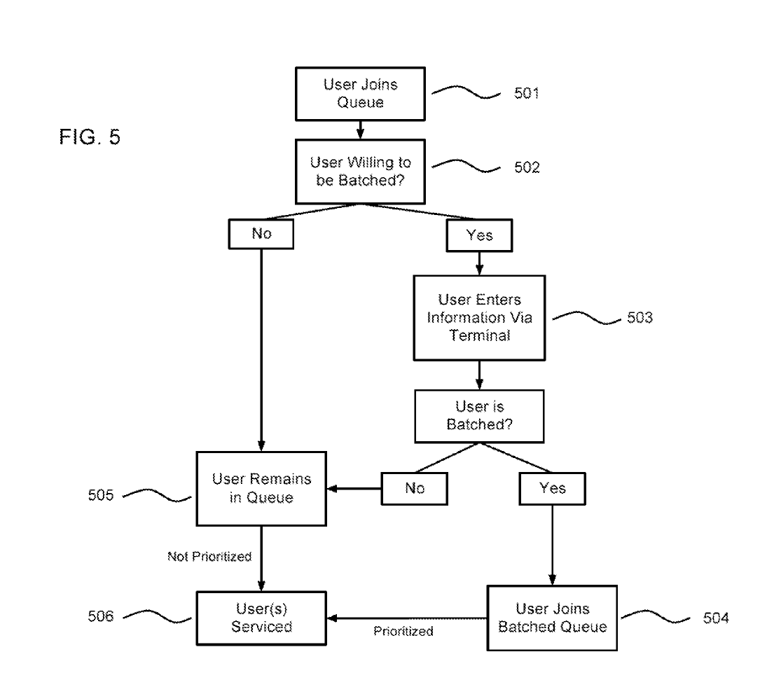

FIG. 5 contains a flow chart illustrating an embodiment of the invention through which queue-members may participate in a batched-queue system.

After joining the queue at step 501, the user can at step 502 either choose to become a candidate for batching or choose to not become a candidate for batching. Those users that do not become batch candidates remain in the queue shown as step 505. Those that do become candidates for batching enter their information via an input terminal at step 503. If a user can be batched, that user gets allocated into the batched-queue shown as step 504. If a user is not batched, that user will remain in the queue shown as step 505. As discussed above, the server determines the order of users to be served, and may prioritize users that are batched, and those users that remain in the queue may not be prioritized. Thus, users that are prioritized may receive advantages such as reduced wait times. The user(s) are serviced at step 506.

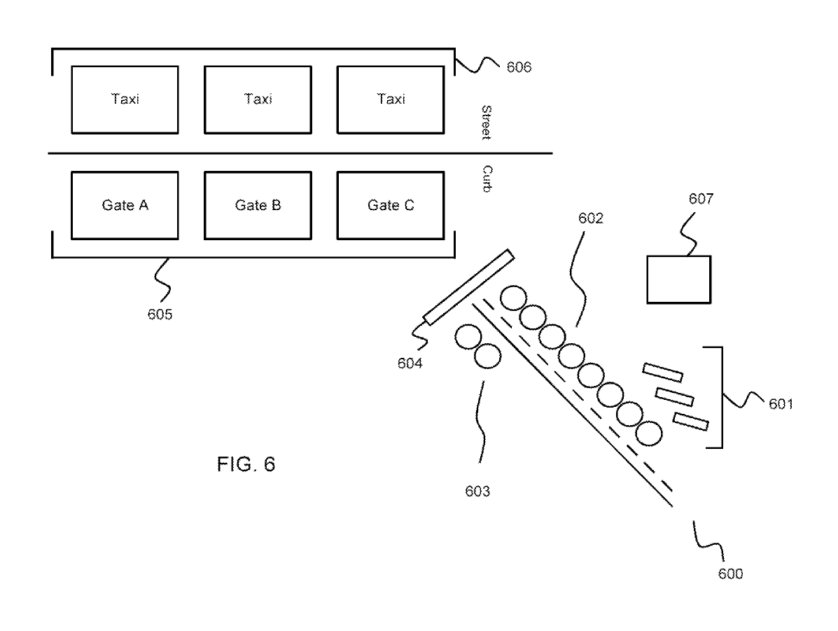

FIG. 6 is a plan view of an embodiment of the invention whereby the queue-resources are rides in for-hire vehicles (e.g., taxis, car service).

In this implementation, users (e.g., potential passengers) may approach the for-hire vehicle stand via entrance 600. Users may then use the stationary input terminals 601 which collect their queue-member characteristics such as, for example, the user destination. If the server 607 finds complementary destinations among other users, which can be serviced with a single for-hire vehicle (e.g., taxi), the server 607 then broadcasts these batches via the broadcast terminal 604. Batched users then join the priority queue 603. Non-batched users join or otherwise remain in the non-priority queue 602. In this implementation, complementarity of queue-member characteristics may be based on user destinations, which can be serviced with one vehicle. The broadcast terminal 604 may direct users to particular gates 605 containing the vehicle (e.g., taxi) 606 to take them to their destination, or may direct users directly to the specific vehicle 606 to take them to their destination.

In this implementation, the system may identify complimentary user destinations in the manner described below.

In response to a user's request for a ride, an initial set of X potentially matching rides (“candidates”) may be extracted from a database according to some of the following criteria: a) geographic proximity of user's requested pick up and drop off locations to the candidate's; b) temporal proximity of user's requested pick up and drop off times to the candidate's; c) available seats in one vehicle.

In this implementation, a shared itinerary may be generated for each candidate that adds in the new user, with rough estimates of travel time. The initial candidate pool may then be narrowed down to some number of top Y ranked candidates in a “filtering” stage. One potential way to narrow down such candidates is according to a scoring method. One example of a scoring method that may be used to assess the complementarity of user destinations is to apply the minimization of a sum of preference functions for each user, with weighted terms for shared trip length versus solo trip length, deviation from preferred pick up time, deviation from preferred drop off time, and shared trip fare versus solo fare.

Shared itineraries may then be generated for these filtered rides with the order of pick up and drop off points chosen to minimize the score defined above using slower, but more precise estimates of travel time, as calculated by, for example, searching a stored street map using Dijkstra's Algorithm or an A* search with edge weights derived from estimated average traffic speeds for each street to find the optimal turn-by-turn route between each pick up and drop off point in the itinerary. The top ranked Z matching rides may then be presented to the user as “proposals” to choose between. Alternatively, only one proposal may be presented to each batched user via the broadcast terminal 604.

X, Y, Z, and the weights for each term used in the score function during the “filtering” and “proposing” stages may be configured based upon the priorities of the particular implementation. Additionally, depending upon the particular implementation, the minimization of preference functions may be applied iteratively through one or more filtering or proposing stages.

In addition to the user destination being a queue-member characteristic evaluated by the system, other embodiments may also evaluate preferred pickup times, or a preferred pickup time window, for a user. In those circumstances, the server may re-assign optimal pickup times to achieve optimal queue-resource deployment.

In such an embodiment, the system may arrange for complementary pick ups and drop offs in a route to satisfy all time window constraints and to minimize a sum of preference functions for each batched user, in which each preference function takes the form of a sigmoid function applied to the dot product of a weight vector and a feature vector with the following terms: a) trip length versus a solo ride; b) deviation from preferred pick up time; c) deviation from preferred drop off time; d) fare saved versus a solo ride; e) slack time in satisfying pick up and drop off window constraints. In this embodiment, adjusted pick up times may then be depicted 402 on mobile input terminals 301, 302, 303, and 304 thereby notifying batched users of their adjusted pick up, drop off and route information.

Additionally, in certain embodiments, the availability of batched users may be increased by identifying popular pick up zones using kernelized k-means clustering with a driving distance metric, and subsequently establishing pick up hubs at the centroids of these zones.

According to the availability of the queue-resource, the server 607 also uses the broadcast terminal 604 to direct batched and non-batched queue-members to the appropriate gate 605, where queue-members are given access to the queue-resource 606 (such as a taxi).

In one embodiment, the queue-resource 606 to which the system is allocating access is rides in for-hire vehicles at transportation hubs.

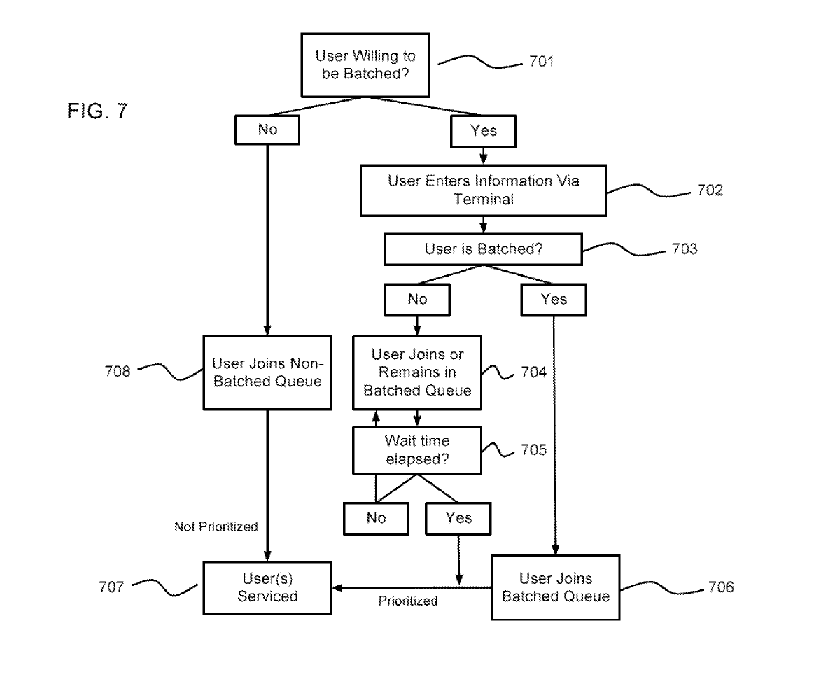

FIG. 7 contains a flow chart illustrating another embodiment of the invention through which queue-members may participate in a batched-queue system.

At step 701, a user decides whether he/she is willing to be batched prior to joining a batched or non-batched queue. If a user is willing to be batched, that user will enter its user-characteristic via a terminal at step 702. If that user is batched, that user will join the batched-queue at step 706, and gain priority access to the queue-resource. If that user is not batched, that user still joins a batched-queue at step 704, but remains in that queue until a designated wait time has elapsed at step 705, at which point that user will gain priority access to the queue-resource. Users who do not wish to be batched join the non-batched queue at step 708, and may not receive priority access to the queue-resource. The user is serviced with the queue-resource at step 707.

It is to be understood that the embodiments are merely illustrative of the present invention and that many variations of the above-described embodiments can be devised by one skilled in the art without departing from the scope of the invention. It is therefore intended that all such variations be included within the scope of the following claims and their equivalents.

1. A queue management system comprising:
at least one input terminal configured to receive a characteristic from a user;
a server configured to receive the characteristic from the at least one input terminal, and wherein the server is further configured to allocate users into a segmented queue comprised of at least one batched-queue containing batches of users assigned to a batch at least in part based on a complementary user characteristic and a non-batched queue comprised of users that have not been assigned to a batch;
a broadcast terminal configured to broadcast information about the segmented queue to the user.

2. The queue management system according to claim 1, wherein the server is configured to determine an order of the users within the segmented queue.

3. The queue management system according to claim 1, wherein the characteristic is comprised of a user destination.

4. The queue management system according to claim 3, wherein the broadcast terminal is comprised of a departures board for facilitating ride sharing.

5. The queue management system according to claim 4, wherein at least one batch of users is comprised of users departing to a complimentary destination.

6. The queue management system according to claim 1, wherein the at least one input terminal comprises a stationary kiosk.

7. The queue management system according to claim 1, wherein the at least one input terminal comprises a wireless device.

8. The queue management system according to claim 7, wherein the broadcast terminal also comprises the wireless device.

9. A computer implemented method for allocating resources comprising:
receiving, by a server from one or more input terminals, a characteristic entered by a user;
allocating, by the server, users with complementary characteristics into batches; and
compiling, by the server, a segmented queue comprised of the batched users and non-batched users.

10. The method according to claim 9, wherein priority in the segmented queue is provided to the batched users over the non-batched users.

11. The method according to claim 10, wherein the priority comprises a shorter wait time for the batched users compared to the non-batched users.

12. The method according to claim 9, further comprising:
assigning a vehicle to the user,
wherein the complementary characteristic may comprise at least one of: a destination location, a pick up time, or a drop off time.

13. The method according to claim 12, wherein the allocation of batches is based at least in part on a minimization of a sum of preference functions for the users, with weighted terms comprised of at least one of the following factors: a shared trip length versus a solo trip length, a deviation from preferred pick up time, a deviation from preferred drop off time, and a trip cost.

14. The method according to claim 13, wherein the minimization of the sum of preference functions is based at least in part on a rough geographic estimate of a trip length.

15. The method according to claim 13, wherein the minimization of the sum of preference functions is based at least in part on a turn-by-turn estimate of a trip length.

16. The method, according to claim 9, wherein the users are selected from pick up zones determined at least in part by applying kernelized k-means clustering with a driving distance metric, and subsequently establishing pick up hubs at the centroids of the zones.

17. A computer implemented method for allocating resources comprising:
receiving, by a server from one or more input terminals, characteristics entered by users;
allocating, by the server, users with complementary characteristics into a batched-queue and users without complementary characteristics into a non-batched queue;
determining, by the server, an overall order comprised of the batched-queue and the non-batched queue; and
transmitting the queue order, from the server, to the user.

18. The method according to claim 17, wherein the transmitting occurs through a broadcast terminal.

19. The method according to claim 17, wherein the one or more input terminals comprises a wireless device.

20. The method according to claim 19, wherein the transmitting occurs through the wireless device.

21. The method according to claim 18, wherein the one or more input terminals comprises a stationary kiosk.

22. The method according to claim 17, wherein the overall order is determined based on awarding priority to users in the batched-queue over users in the non-batched queue.
